(19) United States
(12) Patent Application Publication
(10) Pub. No.: US 2019/0105964 A1
(43) Pub. Date: Apr. 11, 2019

(54) ABUSE DETECTION FOR TRANSPORT REFRIGERATION UNITS

(71) Applicant: Carrier Corporation, Palm Beach Gardens, FL (US)

(72) Inventors: Murat Yasar, West Hartford, CT (US); Mark E. Cywilko, Jamesville, NY (US); Marc Beasley, Beverly, MA (US); Jeffrey Allen Leshuk, Davis, CA (US)

(21) Appl. No.: 16/086,807

(22) PCT Filed: Mar. 22, 2017
(86) PCT No.: PCT/US2017/023589

§ 371 Date: Sep. 20, 2018

Related U.S. Application Data
(60) Provisional application No. 62/312,870, filed on Mar. 24, 2016.

(51) Int. Cl. B60H 1/00; F25D 29/00

(52) U.S. Cl. CPC B60H 1/00978; F25D 29/005; B60H 1/3232; F25D 29/008; B60H 1/00657; F25D 29/003

(57) ABSTRACT

A system for detecting abusive operation of transport refrigeration units (28) is provided. The system includes a storage device (80) to store abuse parameters associated with a transport refrigeration unit (28). Also included is an abuse detection system coupled to the storage device, the abuse detection system including: a diagnostic module (92) to determine the occurrence of abusive operation of the transport refrigeration unit in response to the abuse parameters; a failure probability module (94) to determine a probability of failure for at least one component of the transport refrigeration unit in response to the abuse parameters; and a life extending module (96) to determine adjustments in the operation of at least one component of the transport refrigeration unit in response to the probability of failure.

### BACKGROUND OF THE DISCLOSURE

The embodiments disclosed herein generally relate to cold chain distribution systems, more specifically to an apparatus and a method for detecting the abuse of a transport refrigeration unit within a cold chain distribution system.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated trucks and trailers are commonly used to transport perishable goods in a cold chain distribution system. A transport refrigeration system is mounted to the truck or to the trailer in operative association with a cargo space defined within the truck or trailer for maintaining a controlled temperature environment within the cargo space.

Conventionally, transport refrigeration systems used in connection with refrigerated trucks and refrigerated trailers include a transport refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

The components of a transport refrigeration unit may be periodically inspected and repaired for scheduled maintenance. However, abusive operation of the transport refrigeration unit may alter the schedule for maintenance and increase the occurrences of unscheduled maintenance. Further unscheduled maintenance causes unplanned down time of a unit. Improved systems and particularly improved abuse detection systems would provide both cost and efficiency benefits.

### BRIEF DESCRIPTION OF THE DISCLOSURE

According to one embodiment, a system for detecting abusive operation of transport refrigeration units is provided. The system includes a storage device to store abuse parameters associated with a transport refrigeration unit. Also included is an abuse detection system coupled to the storage device, the abuse detection system including: a diagnostic module to determine the occurrence of abusive operation of the transport refrigeration unit in response to the abuse parameters; a failure probability module to determine a probability of failure for at least one component of the transport refrigeration unit in response to the abuse parameters; and a life extending module to determine adjustments in the operation of at least one component of the transport refrigeration unit in response to the probability of failure.

In addition to one or more of the features described above, or as an alternative, further embodiments of the system may include that the diagnostic module activates an alarm when the occurrence of abusive operation of the transport refrigeration unit is determined.

In addition to one or more of the features described above, or as an alternative, further embodiments of the system may include that the failure probability module activates an alarm when the probability of failure for at least one component of the transport refrigeration system is greater than a selected value.

In addition to one or more of the features described above, or as an alternative, further embodiments of the system may include that the life extending module activates an alarm when adjustments in the operation of at least one component of the transport refrigeration unit will alter the probability of failure of the at least one component of the transport refrigeration unit.

In addition to one or more of the features described above, or as an alternative, further embodiments of the system may include that the alarm is sent to a user device.

In addition to one or more of the features described above, or as an alternative, further embodiments of the system may include that at least one of the storage device and the abuse detection system are located within the transport refrigeration unit.

In addition to one or more of the features described above, or as an alternative, further embodiments of the system may include that the abuse parameters include parameters of the transport refrigeration unit including at least one of operating electrical current, operating temperature, operating pressure, operating vibrations, operation cycles, and operation duration of the transport refrigeration unit.

In addition to one or more of the features described above, or as an alternative, further embodiments of the system may include a location tracking sensor to detect time-based locations of the transport refrigeration unit and assign the time-based locations to the abuse parameters.

In addition to one or more of the features described above, or as an alternative, further embodiments of the system may include the life extending module adjusts the operation of the transport refrigeration unit when adjustments in the operation of at least one component of the transport refrigeration unit will alter the probability of failure of the at least one component of the transport refrigeration unit.

According to another embodiment, a method of detecting abusive operation of transport refrigeration units, the method is provided. The method includes storing, using a storage device, abuse parameters associated with a transport refrigeration unit. The method also includes monitoring, using an abuse detection system, the transport refrigeration unit, the abuse detection system coupled to the storage device, the abuse detection system including: a diagnostic module to determine the occurrence of abusive operation of the transport refrigeration unit in response to the abuse parameters; a failure probability module to determine a probability of failure for at least one component of the transport refrigeration unit in response to the abuse parameters; and a life extending module to determine adjustments in the operation of at least one component of the transport refrigeration unit in response to the probability of failure.

In addition to one or more of the features described above, or as an alternative, further embodiments of the method may include activating an alarm, using the diagnostic module, when the occurrence of abusive operation of the transport refrigeration unit is determined.

In addition to one or more of the features described above, or as an alternative, further embodiments of the method may include activating an alarm, using the failure probability module, when the probability of failure for at least one component of the transport refrigeration system is greater than a selected value.

In addition to one or more of the features described above, or as an alternative, further embodiments of the method may include activating an alarm, using the life extending module, when adjustments in the operation of at least one component of the transport refrigeration unit will alter the probability of failure of the at least one component of the transport refrigeration unit.

In addition to one or more of the features described above, or as an alternative, further embodiments of the method may include that the alarm is sent to a user device.

In addition to one or more of the features described above, or as an alternative, further embodiments of the method may include that at least one of the storage device and the abuse detection system are located within the transport refrigeration unit.

In addition to one or more of the features described above, or as an alternative, further embodiments of the method may include that the abuse parameters include parameters of the transport refrigeration unit including that at least one of operating electrical current, operating temperature, operating pressure, operating vibrations, operation cycles, and operation duration of the transport refrigeration unit.

In addition to one or more of the features described above, or as an alternative, further embodiments of the method may include detecting, using a location tracking sensor, time-based locations of the transport refrigeration unit and assign the time-based locations to the abuse parameters.

In addition to one or more of the features described above, or as an alternative, further embodiments of the method may include adjusting, using the life extending module, the operation of the transport refrigeration unit when adjustments in the operation of at least one component of the transport refrigeration unit will alter the probability of failure of the at least one component of the transport refrigeration unit.

Other aspects, features, and techniques of the invention will become more apparent from the following description taken in conjunction with the drawings.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of a system for detecting abusive operation of a transport refrigeration unit for use in a cold chain distribution system, according to an embodiment of the present disclosure; and

FIG. 2 illustrates a schematic view a cold chain distribution system that may incorporate embodiments of the present disclosure.

### DETAILED DESCRIPTION OF THE DISCLOSURE

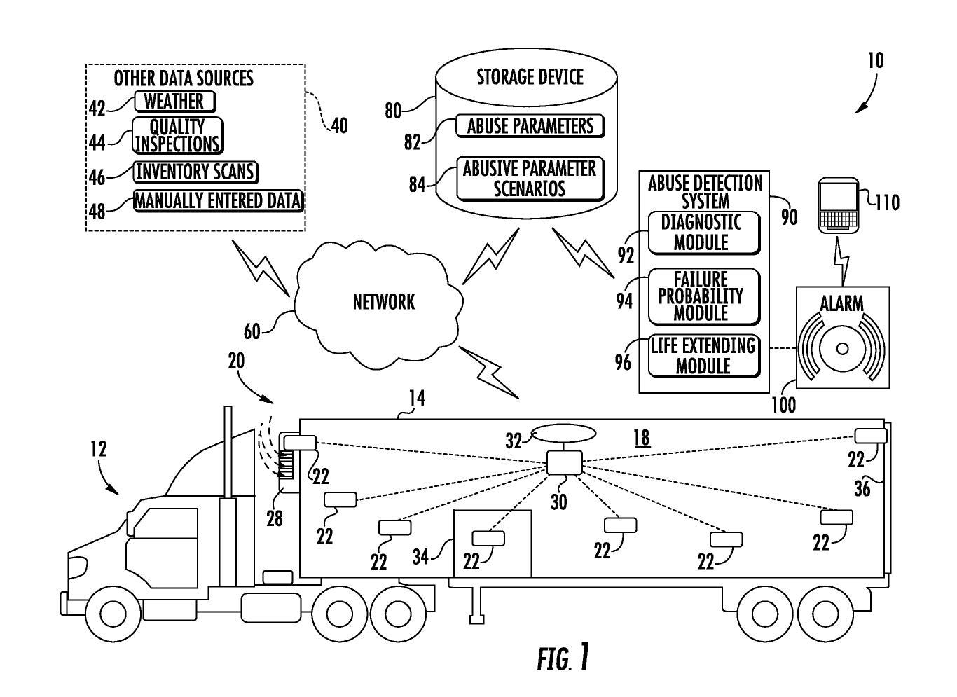

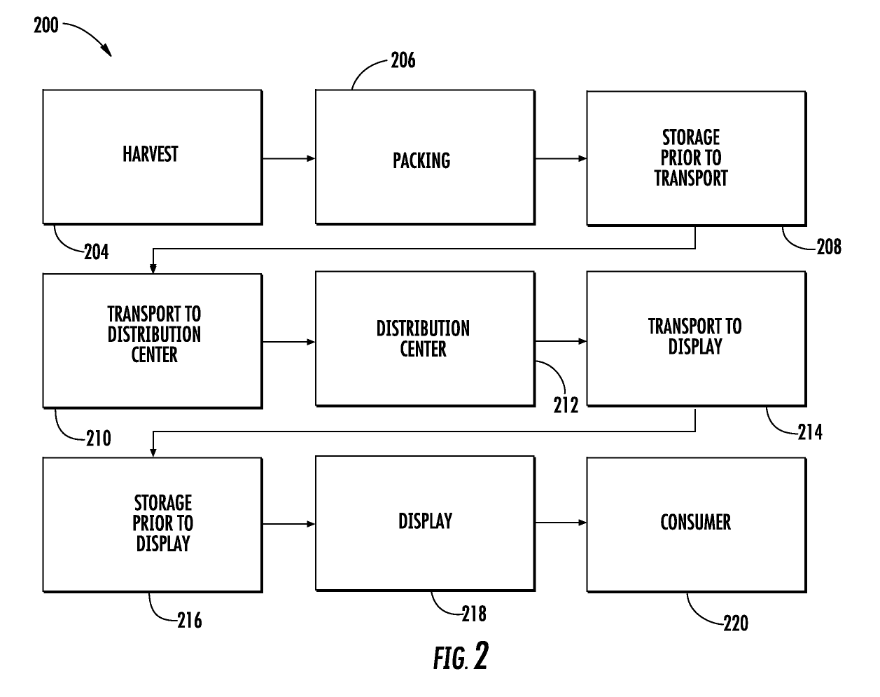

Referring now to the drawings, FIG. 1 illustrates a schematic view of a system 10 for detecting abusive operation of a transport refrigeration unit 28 for use in a cold chain distribution system 200, according to an embodiment of the present disclosure. FIG. 2 illustrates a schematic view a cold chain distribution system 200 that may incorporate embodiments of the present disclosure. Typically, transport refrigeration systems 20 are used to transport and distribute perishable goods and environmentally sensitive goods (herein referred to as perishable goods 34). In the illustrated embodiment, a transport refrigeration system 20 includes an environmentally controlled container 14, a transport refrigeration unit 28 and perishable goods 34. The container 14 may be pulled by a tractor 12. It is understood that embodiments described herein may be applied to shipping containers that are shipped by rail, sea, or any other suitable container, without use of a tractor 12. The container 14 may define an interior compartment 18.

In the illustrated embodiment, the transport refrigeration unit 28 is associated with a container 14 to provide desired environmental parameters, such as, for example temperature, pressure, humidity, carbon dioxide, ethylene, ozone, light exposure, vibration exposure, and other conditions to the interior compartment 18. In further embodiments, the transport refrigeration unit 28 is a refrigeration system capable of providing a desired temperature and humidity range. The perishable goods 34 may include but are not limited to fruits, vegetables, grains, beans, nuts, eggs, dairy, seed, flowers, meat, poultry, fish, ice, blood, pharmaceuticals, or any other suitable cargo requiring cold chain transport.

In the illustrated embodiment, the transport refrigeration system 20 includes sensors 22. The sensors 22 may be utilized to monitor abuse parameters 82. The abuse parameters 82 monitored may include environmental conditions that the perishable goods 34 are exposed to such as, for example temperature, pressure, humidity, carbon dioxide, ethylene, ozone, light exposure, vibrations, and other conditions in the interior compartment 18. Accordingly, suitable sensors 22 are utilized to monitor the desired parameters. Advantageously, sensors 22 may be selected for certain applications depending on the perishable cargo to be monitored and the corresponding environmental sensitivities. In an embodiment, temperatures are monitored. In certain embodiments, a user desires to maintain and monitor temperatures or other parameters within an acceptable range. As seen in FIG. 1, the sensors 22 may be placed directly on the perishable goods 34.

Further, as in the illustrated embodiment, sensors 22 may be used to monitor various abuse parameters 82 regarding the operation of the transport refrigeration system 20. These sensors 22 may be placed in a variety of locations throughout the transport refrigeration system 20 including but not limited to on the transport refrigeration unit 28, on a door 36 of the container 14 and throughout the interior compartment 18. The sensors 22 may be placed directly within the transport refrigeration unit 28 to monitor the performance of the transport refrigeration unit 28. Individual components internal to the transport refrigeration unit 28 may also be monitored by sensors 22 to detect operation aspects of the overall transport refrigeration unit 28 and the individual components, including but not limited to operating electrical current, operating temperature, operating pressure, operating vibrations, operation cycles, and operation duration of the transport refrigeration unit 28. For example, current sensors may detect if the operator abusively operated the transport refrigeration unit 28 when an electrical fan motors or other components had already failed. In another example, vibration and accelerometer sensors may detect abusive handling of the container 14.

As seen, the sensors 22 may also be placed on the door 36 of the container 14 to monitor the position of the door 36. Whether the door 36 is open or closed affects both the temperature of the container 14 and the stress imposed on the transport refrigeration unit 28. For instance, in hot weather, an open door 36 will allow cooled air to escape from the container 14, causing the temperature of the interior compartment 18 to rise, which creates additional stress on the transport refrigeration unit 28 by forcing the transport refrigeration unit 28 to work harder to cool the interior compartment 18. Leaving the door open unnecessarily for long periods of time may be indicative of abusive operation. Additionally, the sensors 22 may include a location tracking sensor to detect time-based locations of the transport refrigeration unit and assign the time-based locations to the abuse parameters 82. In order to determine the location the location tracking sensor may utilize systems such as, for example global positioning system (GPS) or cellular triangulation. The time-based location may help pinpoint when and where the abusive behavior might have occurred.

As illustrated in FIG. 1, the transport refrigeration system 20 may further include, a controller 30 configured to log a plurality of readings from the sensors 22, known as abuse parameters 82, at a selected sampling rate. The abuse parameters 82 may further be augmented with time, position stamps or other relevant information when logged. The controller 30 may be enclosed within the transport refrigeration unit 28 or separate from the transport refrigeration unit 28 as illustrated. The controller 30 may also include a processor (not shown) and an associated memory (not shown). The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

In the illustrated embodiment, the transport refrigeration system 20 may include a communication module 32 in operative communication with the controller 30 and in wireless operative communication with a network 60. The communication module 32 is configured to transmit the abuse parameters 82 to the network 60 via wireless communication. The wireless communication may be, but is not limited to, radio, microwave, cellular, satellite, or another wireless communication method. The network 60 may be but is not limited to satellite networks, cellular networks, cloud computing network, wide area network, or another type of wireless network. The communication module 32 may include a short range interface, wherein the short range interface includes at least one of: a wired interface, an optical interface, and a short range wireless interface.

Abuse parameters 82 may also be provided by other data sources 40, as illustrated in FIG. 1. These other data sources 40 may be collected at any point throughout the cold chain distribution system 200, which may include harvest 204, packing 206, storage prior to transport 208, transport to distribution center 210, distribution center 212, transport to display 214, storage prior to display 216, display 218, and consumer 220, as illustrated in FIG. 2. These stages are provided for illustrative purposes and a distribution chain may include fewer stages or additional stages, such as, for example a cleaning stage, a processing stage, and additional transportation stages. The other data sources 40 may include, but are not limited to, weather 42, quality inspections 44, inventory scans 46, and manually entered data 48.

The weather 42, has an effect on the operation of the transport refrigeration unit 28 by influencing the temperature of the container 14 during transport (e.g. 210 and 214). The sensed location may help in providing information from other data sources 40 regarding local weather 42 (including solar gain) experienced by the container 14 along the travel route. The weather 42 affects the temperature of the container 14 and thus affects the operation on the transport refrigeration unit 28. For instance, the transport refrigeration unit 28 may have to work harder on a container 14 travelling through a desert that is exposed to long period of heat and solar gain. The weather 42 also has other influences on the transport refrigeration unit 28. For instance, the weather 42 prior to and at harvest 204 may have an impact on the quality of the perishable goods 34, which in turn would affect how hard the transport refrigeration unit 28 must work to preserve the perishable goods 34.

Moreover, quality inspections 44, similar to the weather 42, may reveal data of the perishable goods 34 that may affect how hard the transport refrigeration unit 28 must work to preserve the perishable goods 34. Quality inspections 44 may be done by a machine or a human being. Quality inspections 44 performed by a machine may be accomplished using a variety of techniques including but not limited to optical, odor, soundwave, infrared, or physical probe.

Further inventory scans 46, may also reveal information about the perishable goods 34 that may affect how hard the transport refrigeration unit 28 must work to preserve the perishable goods 34. For instance, the inventory scan 46 may reveal a temperature of the distribution center 212 where the perishable goods 34 were kept and thus the transport refrigeration unit 28 must either increase or decrease its output to bring the perishable goods 34 to the correct temperature. Improperly cooling the perishable goods at a distribution center 212 and thus forcing the transport refrigeration unit 28 to greatly increase its output to the pull down the temperature of the goods may indicate abusive behavior. While the system 10 includes sensors 22 to aid in automation, often times the need for manual data entry is unavoidable. The manually entered data 48 may be input via a variety of devices including but not limited to a cellular phone, tablet, laptop, smartwatch, a desktop computer or any other similar data input device.

In the illustrated embodiment, the system 10 further includes a storage device 80 to store abuse parameters 82 associated with the transport refrigeration unit 28. The storage device 80 may also store abusive parameter scenarios 84 of the transport refrigeration unit 28. The storage device 80 may be but is not limited to a random access memory (RAM), read only memory (ROM), or other electronic, optical, magnetic or any other computer readable medium.

In the illustrated embodiment, the system 10 further includes an abuse detection system 90. The abuse detection system 90 and the storage device 80 may be located within the transport refrigeration unit 28 or connected to the transport refrigeration unit 28 via the network 60. As shown, the abuse detection system 90 may include a diagnostic module 92, a failure probability module 94, and a life extending module 96. The abuse detection system 90 may also include a processor and an associated memory. The memory may be the storage device 80 or another separate memory device. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium. The abuse detection system 90 may transfer data via the network 60 data or by any suitable local method, including, but not limited to USB, serial transmission, optical transmission, local Wi-Fi, personal area networks, or any other suitable local interface.

The diagnostic module 92, failure probability module 94, and life extending module 96 may utilize abusive parameter scenarios 84. The abusive parameter scenarios 84 may provide information such as, for example, life curves, failure rates, and a selected range of conditions for each component of the transport refrigeration unit 28. The selected range of conditions may define the normal and/or non-abusive operation of the transport refrigeration unit 28. Operation outside of the selected range of conditions may indicate abuse of a component of the transport refrigeration unit 28.

The diagnostic module 92 determines the occurrence of abusive operation of the transport refrigeration unit 28 in response to the abuse parameters 82. The diagnostic module 92 may detect abuse in the transport refrigeration unit 28 and provide an indication of the potential sources for the abuse. The diagnostic module 92 may compare the abuse parameters 82 to abusive parameter scenarios 84 such as, for example thresholds, limits, and ranges to detect abuse. Then diagnostic module 92 may derive one or more potential sources for the abuse. A sensor 22 may also be configured as a location tracking sensor to detect time-based location of the transport refrigeration unit 28 and assign the time-based location to the abuse parameters 82. The time based location can help narrow down where and when the abuse occurred. The diagnostic module 92 activates an alarm 100 when the occurrence of abusive operation of the transport refrigeration unit 28 is determined.

The failure probability module 94 determines a probability of failure for at least one component of the transport refrigeration unit 28 in response to the abuse parameters 82. The failure probability module 94 activates an alarm 100 when the probability of failure for at least one component of the transport refrigeration unit 28 is greater than a selected value. The failure probability module 94 may detect patterns in the abuse parameters 82 (e.g., patterns of high/low compressor outlet pressure) to predict the failure probability. The failure probability module 94 may use a baseline life curve which provides remaining life as a function of time to determine failure probability. The baseline life curve may be generated based on the abusive parameter scenarios 84. The baseline life curve may be adjusted or shifted in response to events or abuse parameters 82.

The life extending module 96 determines adjustments in the operation of at least one component of the transport refrigeration unit 28 in response to the probability of failure. The life extending module 96 may use a baseline life curve which provides remaining life as a function of time to determine adjustments in operation of at least one component of the transport refrigeration unit 28 to alter failure probability. The baseline life curve may be generated based on the abusive parameter scenarios 84. The baseline life curve may be adjusted or shifted in response to events or abuse parameters 82. The life extending module 96 activates an alarm 100 when adjustments in the operation of at least one component of the transport refrigeration unit 28 will alter the probability of failure of the at least one component of the transport refrigeration unit 28. For example, having the transport refrigeration unit 28 cool the interior compartment 18 to a required 34° for strawberries may cause the transport refrigeration unit to failure prior to reaching its destination; however the transport refrigeration unit 28 will survive the entire journey without total loss of strawberry quality if only cooling the interior compartment 18 to 38°. The life extending module 96 may also adjust the operation of the transport refrigeration unit 28 when adjustments in the operation of at least one component of the transport refrigeration unit 28 will alter the probability of failure of the at least one component of the transport refrigeration unit 28. The life extending module 96 may be located on the transport refrigeration unit 28 and control operation directly, or send commands remotely over the network 60 to adjust operation of the transport refrigeration unit 28.

The alarm 100 may be an alert sent wirelessly via the network 60 or other wireless communication to a user device 110 such as, for example, a cellular phone, tablet, laptop, smartwatch, desktop computer or any similar device. The alarm 100 may be an instantaneous alarm or a scheduled alarm for a later time. The wireless communication may be, but is not limited to, radio, microwave, cellular, satellite, or another wireless communication method.

Advantageously, as provided herein, the abuse detection system 90 may help to better identify abusive operators of transport refrigeration units 28, so that owners may adjust leasing rates accordingly. For instance, an abusive operator may need to pay a higher leasing fee than a non-abusive operator. One time abuse may not be an issue but persistent and continuance abuse may be an issue.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A system for detecting abusive operation of transport refrigeration units, the system comprising:
a storage device to store abuse parameters associated with a transport refrigeration unit;
an abuse detection system coupled to the storage device, the abuse detection system including:
a diagnostic module to determine the occurrence of abusive operation of the transport refrigeration unit in response to the abuse parameters;
a failure probability module to determine a probability of failure for at least one component of the transport refrigeration unit in response to the abuse parameters; and
a life extending module to determine adjustments in the operation of at least one component of the transport refrigeration unit in response to the probability of failure.

2. The system of claim 1, wherein:
the diagnostic module activates an alarm when the occurrence of abusive operation of the transport refrigeration unit is determined.

3. The system of claim 1, wherein:
the failure probability module activates an alarm when the probability of failure for at least one component of the transport refrigeration system is greater than a selected value.

4. The system of claim 1, wherein:
the life extending module activates an alarm when adjustments in the operation of at least one component of the transport refrigeration unit will alter the probability of failure of the at least one component of the transport refrigeration unit.

5. The system of claim 2, wherein:
the alarm is sent to a user device.

6. The system of claim 1, wherein:
at least one of the storage device and the abuse detection system are located within the transport refrigeration unit.

7. The system of claim 1, wherein:
the abuse parameters include parameters of the transport refrigeration unit including at least one of operating electrical current, operating temperature, operating pressure, operating vibrations, operation cycles, and operation duration of the transport refrigeration unit.

8. The system of claim 1, further comprising:
a location tracking sensor to detect time-based locations of the transport refrigeration unit and assign the time-based locations to the abuse parameters.

9. The system of claim 1, wherein:
the life extending module adjusts the operation of the transport refrigeration unit when adjustments in the operation of at least one component of the transport refrigeration unit will alter the probability of failure of the at least one component of the transport refrigeration unit.

10. A method of detecting abusive operation of transport refrigeration units, the method comprising:
storing, using a storage device, abuse parameters associated with a transport refrigeration unit;
monitoring, using an abuse detection system, the transport refrigeration unit, the abuse detection system coupled to the storage device, the abuse detection system including:
a diagnostic module to determine the occurrence of abusive operation of the transport refrigeration unit in response to the abuse parameters;
a failure probability module to determine a probability of failure for at least one component of the transport refrigeration unit in response to the abuse parameters; and
a life extending module to determine adjustments in the operation of at least one component of the transport refrigeration unit in response to the probability of failure.

11. The method of claim 10, further comprising:
activating an alarm, using the diagnostic module, when the occurrence of abusive operation of the transport refrigeration unit is determined.

12. The method of claim 10, further comprising:
activating an alarm, using the failure probability module, when the probability of failure for at least one component of the transport refrigeration system is greater than a selected value.

13. The method of claim 10, further comprising:
activating an alarm, using the life extending module, when adjustments in the operation of at least one component of the transport refrigeration unit will alter the probability of failure of the at least one component of the transport refrigeration unit.

14. The method of claim 11, wherein:
the alarm is sent to a user device.

15. The method of claim 10, wherein:
at least one of the storage device and the abuse detection system are located within the transport refrigeration unit.

16. The method of claim 10, wherein:
the abuse parameters include parameters of the transport refrigeration unit including at least one of operating electrical current, operating temperature, operating pressure, operating vibrations, operation cycles, and operation duration of the transport refrigeration unit.

17. The method of claim 10, further comprising:
detecting, using a location tracking sensor, time-based locations of the transport refrigeration unit and assign the time-based locations to the abuse parameters.

18. The method of claim 10, further comprising:
adjusting, using the life extending module, the operation of the transport refrigeration unit when adjustments in the operation of at least one component of the transport refrigeration unit will alter the probability of failure of the at least one component of the transport refrigeration unit.

19. The method of claim 12, wherein:
the alarm is sent to a user device.

20. The method of claim 13, wherein:
the alarm is sent to a user device.
